(19) United States
(12) Patent Application Publication
(10) Pub. No.: US 2006/0086052 A1
(43) Pub. Date: Apr. 27, 2006

(54) Slider window with continuous seals

(76) Inventors: Gabriel Petta, Woodbridge (CA); Rolf J. Ohrstrom, Toronto (CA)

Correspondence Address: BERESKIN AND PARR, 40 KING STREET WEST, BOX 401, TORONTO, ON, M5H 3Y2, CA

(21) Appl. No.: 11/256,197

(22) Filed: Oct. 24, 2005

Related U.S. Application Data
(60) Provisional application No. 60/621,032, filed on Oct. 22, 2004.
(60) Provisional application No. 60/621,027, filed on Oct. 22, 2004.

(51) Int. Cl. E05D 15/16

(52) U.S. Cl. 49/404

(57) ABSTRACT

A frame assembly for a window includes a master frame and first and second sash frames mounted in the master frame. The first sash frame is slidable within the master frame along a sliding axis. The first sash frame has a lock rail and the second sash frame has a keeper rail, the lock rail and keeper rail generally overlapping each other when the window is closed. The lock rail has a first seal coupler segment extending continuously along the entire length thereof for attaching a length of weatherstripping to the lock rail.

This application claims the benefit under 35 USC 119(e) of U.S. Provisional Application Nos. 60/621,027, filed on Oct. 22, 2004, and 60/621,032, filed on Oct. 22, 2004, the entire contents of which are hereby incorporated by reference.

### FIELD OF THE INVENTION

This present invention relates to slider windows. More particularly, the present invention relates to a slider window having a sash with a generally continuous seal coupler for attaching seals to the sash.

### BACKGROUND OF THE INVENTION

Known slider windows can have a master frame with two sashes supported in the master frame. At least one of the sashes can be slidable within the master frame for opening and closing the window.

To seal against wind and rain, it is known to provide weatherstripping between adjacent surfaces of the sashes and the master frame, and between adjacent surfaces of the two sashes where they overlap when closed (i.e. at the meeting rails or meeting stiles). The weatherstripping can be supported in slots provided in the sash frames, but these slots are generally discontinuous in terms of the extension of the slots around the perimeter of the respective sash frames.

For example, in typical windows known in the prior art, the slots in the sash frames are notched at the upper and lower ends of the meeting rails of the sash frames. The notches result in a portion of the slot being shorter in length than the respective meeting rail, leaving a slot gap. As well, the slots provided along the meeting rails are generally not coplanar with slots in the remainder of the respective sashes. To accommodate the discontinuities and to seal the notch area, dust plugs are required, having a length sufficient to span the slot gap, and a width or thickness sufficient to span the distance from the meeting rail slot to the remaining coplanar slots.

Furthermore, the master frames of known slider windows generally have distinct extrusions for respective header and sill members of the master frame. In a known window, the header extrusion typically has a generally horizontal surface (in cross-section) adjacent the upper member of the sash, and the sill typically has an inclined surface (in cross-section) adjacent the lower member of the sash. Sash supporting tracks are typically attached to the respective surfaces of the header and sill, using a combination of snap-fit assembly and caulking.

### SUMMARY OF THE INVENTION

In some embodiments, the present invention provides a slider window that can be free of dust plugs for sealing out the weather. In some embodiments, slider windows of the present invention can use extrusion profiles common to at least two framing members to facilitate manufacture and reduce cost. In some embodiments, the present invention provides a slider window having a track attached to a sill in snap-fit, the track having channels for slidably supporting a sash. These and other features of the present invention can be understood further with reference to the Figures and Description provided hereinafter. The invention may reside in features of one or more embodiments taken singly or in combination with those of other embodiments.

In accordance with a first aspect, the present invention provides a frame assembly for a window having a master frame and at least one operable sash slidably supported within the master frame. The sash has a seal coupler for securing a seal element to the sash. The seal element can be n the form of a length of weatherstripping. In some embodiments, the seal coupler extends generally continuously around the perimeter of the sash.

The sash frame can have a glazing recess for receiving the glazing, and the seal coupler can be laterally offset from the glazing recess. The seal coupler can be generally coplanar around the perimeter of the sash frame, in a plane that is generally parallel to the glazing. The sash frame can include upper and lower horizontal frame members extending between spaced-apart vertical frame members, the horizontal and vertical frame members formed of extruded lineals cut to length and connected together at their ends. The seal couplers can be integral to the extruded lineals. The upper and lower horizontal frame members can have a common sash extrusion profile. At least one of the vertical frame members can have the common sash extrusion profile. The seal coupler can include a pair of laterally inwardly directed retaining rails forming a T-slot for receiving a flanged backing of a length of weatherstripping. Each of the extruded lineals can include the pair of rails and a glazing recess for supporting the periphery of a glazing unit mounted in the sash frame.

The master frame can include a sill and a header each extending between spaced-apart jambs, the sill, header and jambs being formed of extrusions cut to length and connected together at their ends. The sill and header can include a sill track and header track, respectively, providing opposed channels for slidably supporting the sash. The sill track and header track can be formed of extrusions separately attached to the to the sill and header, respectively. The sill track and header track can be attached to the sill and header, respectively, by snap fit assembly. The sill and header can each be provided with a pair of spaced-apart retaining claws for engaging barbs extending from the respective sill track and header track. The retaining claws can be integrally extruded with the sill and header. The sill and header can have a common horizontal member extrusion profile. The sill track can have a co-extruded sealing fin for bearing against the sill to seal out the weather. The opposed channels of the master frame can have a width defining a channel width, and the width of the sash frame including the seal coupler can be narrower than the channel width.

According to another aspect of the present invention, a frame assembly for window includes a master frame and first and second sash frames mounted in the master frame. The first sash frame is slidable within the master frame along a sliding axis for opening and closing the window. The first sash frame has a lock rail and the second sash frame has a keeper rail, the lock rail and keeper rail generally overlapping each other when the window is closed. The lock rail has a first seal coupler segment extending continuously along the entire length of the lock rail for attaching a length of weatherstripping to the lock rail.

The lock rail can include a first extruded lineal with mitered lock rail ends, and the first seal coupler segment can be coterminous with the mitered lock rail ends. The first sash frame can include second and third seal coupler segments extending from respective ends of the first coupler segment in a direction parallel to the sliding axis. The keeper rail can include a first seal surface that is disposed, when the window is closed, opposite to and extends continuously along the length of the first seal coupler segment for engaging the weatherstripping. The keeper rail can include a second extruded lineal with mitered keeper rail ends, and the first seal surface can be coterminous with the mitered keeper rail ends. The keeper rail can include a fourth seal coupler segment extending continuously between the mitered keeper rail ends. The second sash frame can include fifth and sixth seal coupler segments extending from respective ends of the fourth coupler segment in a direction parallel to the sliding axis.

### BRIEF DESCRIPTION OF THE DRAWINGS

For a better understanding of the present invention and to show more clearly how it would be carried into effect, reference will now be made by way of example, to the accompanying drawings that show a preferred embodiment of the present invention, and in which:

FIG. 1 is a perspective view of a window according to one embodiment of the present invention;

FIG. 2 is an exterior elevation view of the window of FIG. 1;

FIG. 3 is an exploded isometric view of a frame element of the window of FIG. 1;

FIG. 4 is a section view of the window of FIG. 2 taken across the lines 4-4;

FIG. 5 is a section view of the window of FIG. 2 taken across the line 5-5;

FIG. 6 is an enlarged view of a horizontal member of FIG. 4;

FIG. 7 is a section view of the window of FIG. 2 taken across the line 7-7;

FIG. 7a is an enlarged view of a central portion of the window shown in FIG. 7;

FIG. 8 is a side view of a vertical member of the window of FIG. 1;

FIG. 9 is a section view of the vertical member of FIG. 7 taken along the line 9-9;

FIG. 10 is an enlarged view of a header track element of the window shown in FIG. 4;

FIG. 11 is an enlarged view of a sill track element of the window shown in FIG. 4;

FIG. 12 is a partially exploded isometric view of the window of FIG. 1;

FIG. 13 is a perspective view of a seal element of the window of FIG. 1;

FIG. 14 is a cross-sectional view of a seal coupling portion of a sash frame element of the window of FIG. 1;

FIG. 15 is a perspective view of a sash frame element of the window of FIG. 1;

FIGS. 16 and 17 are perspective views of a sash frame element known in the prior art;

FIG. 18 is a partially exploded view of the sash frame element of FIG. 15;

FIG. 19 is a cross-sectional view of an extrusion of sash frame elements of the window of FIG. 1;

FIG. 20 is a cross-sectional view of an extrusion element of the sash frame element of FIG. 15;

FIG. 21 is a perspective view of a portion of the sash frame of FIG. 15 and a portion of the header track element of FIG. 10;

FIG. 22 is a perspective view of a portion of another sash element of the window of FIG. 1;

FIG. 23 is a partially exploded view of the sash frame element of FIG. 22;

FIG. 24 is a cross-sectional view of an extrusion element of the sash frame element of FIG. 22; and

FIG. 25 is a perspective view of a portion of the sash frame element of FIG. 22 and a portion of the header track element of FIG. 10.

### DETAILED DESCRIPTION OF THE INVENTION

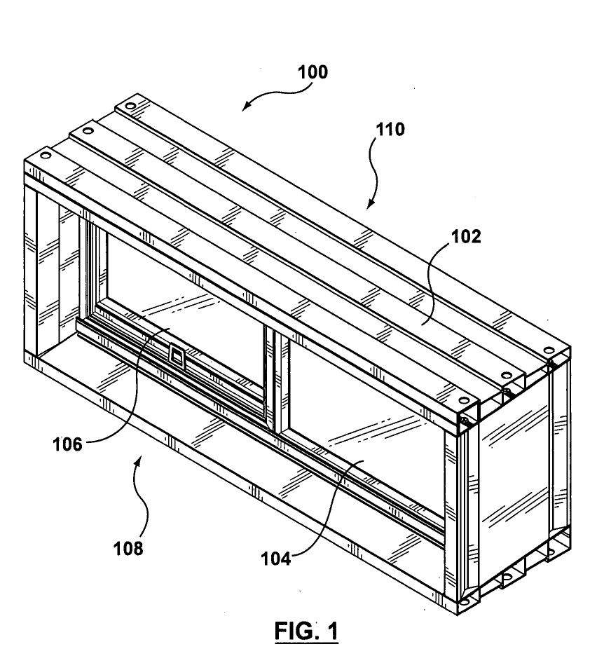

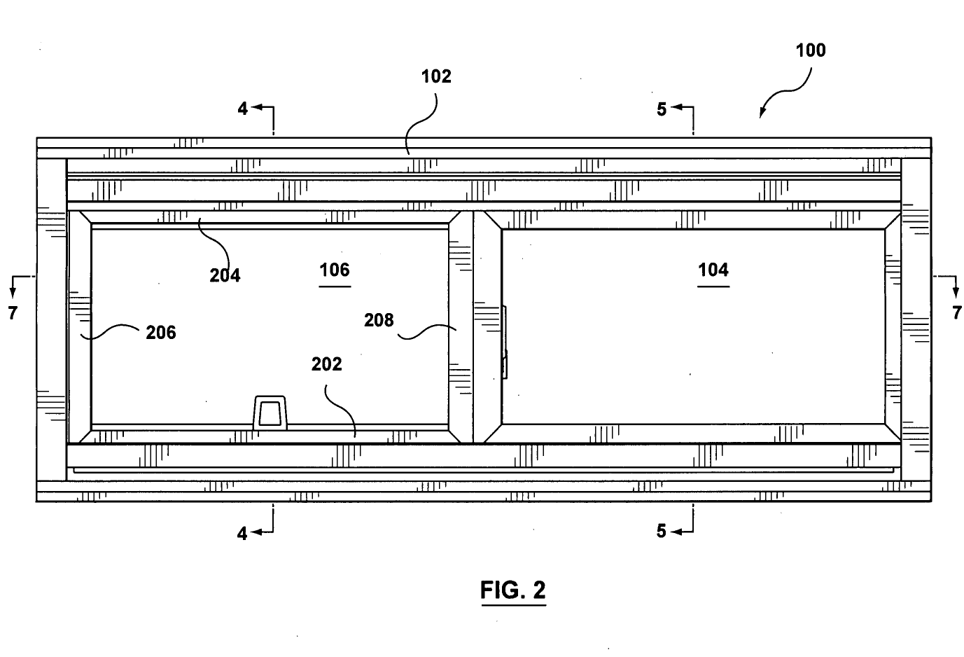

A slider window 100 according to the present invention is shown generally in FIGS. 1 and 2. The window 100 has a master frame 102 and, in the embodiment illustrated, a fixed sash 104 and an operable or slidable sash 106 mounted in the master frame 102. The window 100 is adapted for installation in a wall, and has an exterior face 108 and interior face 110 directed towards respective exterior and interior spaces on either side of the wall.

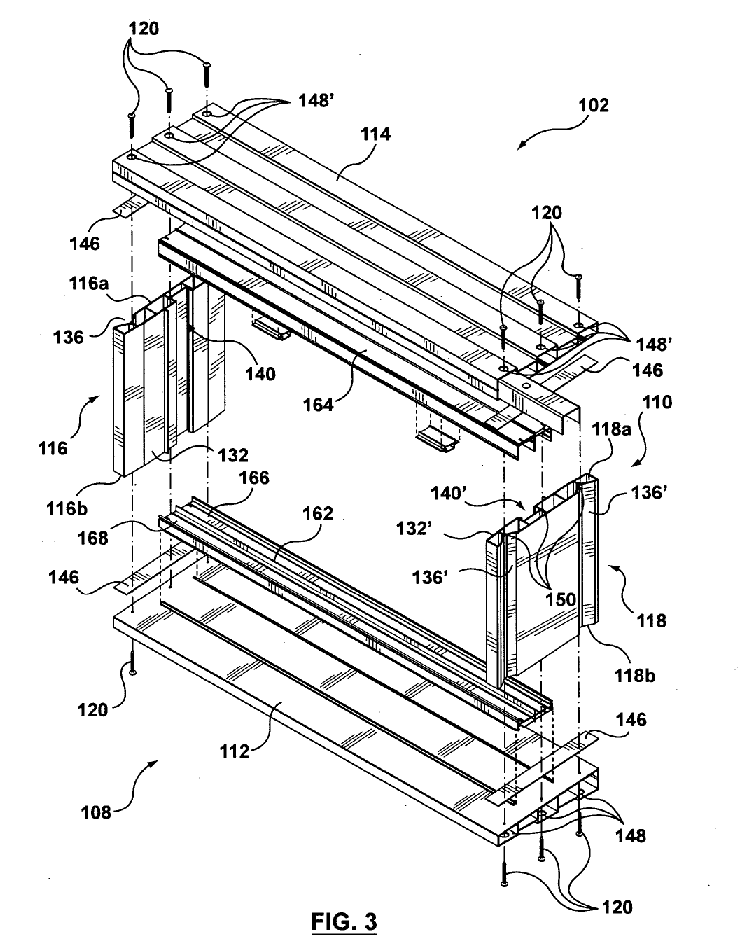

Referring now to FIG. 3, the master frame 102 is generally rectangular, having a lower horizontal member or sill 112, an upper horizontal member or header 114, and spaced apart vertical members or jambs 116 and 118 extending between opposite ends of the sill 112 and header 114. In the embodiment illustrated, the jamb 116 is adjacent the operable sash 106 and referred to as a vent side jamb 116. The jamb 118 is adjacent the fixed sash 104, is referred to as a fixed side jamb 118. The sill 112, header 114, and jambs 116 and 118 can be of an extruded plastic material, cut to length and assembled with suitable fasteners such as, for example, but not limited to, screws 120.

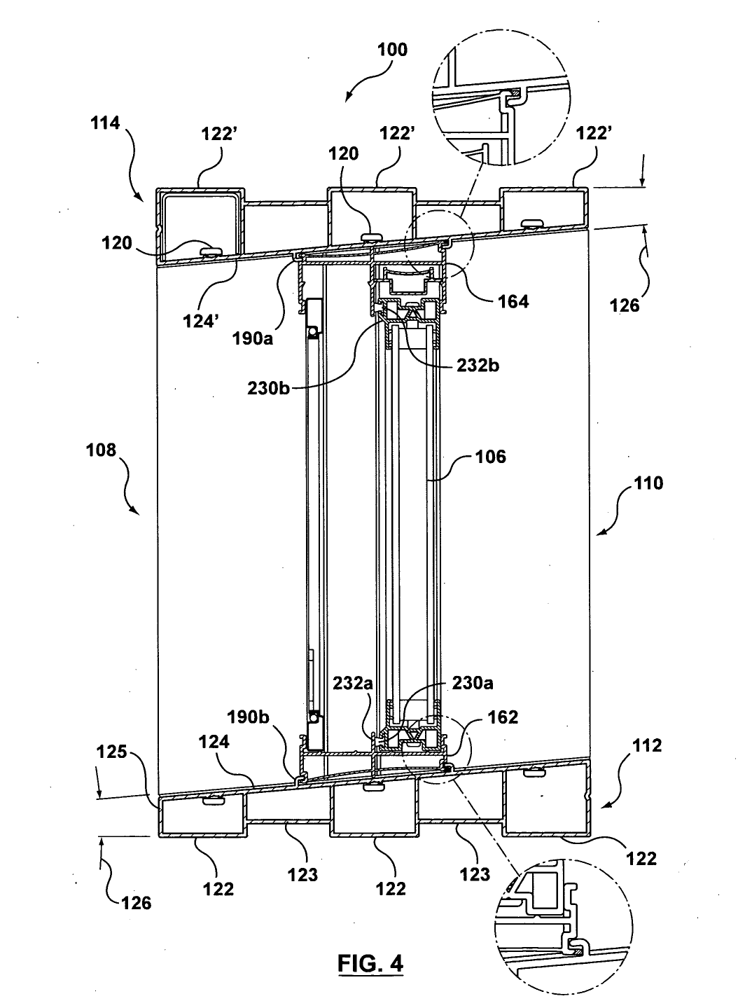

As best seen in FIGS. 4, 5 and 6, an extrusion profile 113 can be cut to lengths to provide the sill 112 and header 114. In other words, the sill 112 and header 114 can have a common length and profile so that they are interchangeable. This can reduce inventory stocking proliferation, and can also simplify manufacturing and reduce tooling costs, since a single extrusion 113 can be used to provide sills 112 or headers 114.

In the embodiment illustrated, the sill 112 has an inner surface 124 directed towards the header 114, and an outer surface 122 opposite the inner surface 124. The outer surface 122 is, in the embodiment illustrated, generally aligned in a plane perpendicular to the exterior and interior faces 108, 110 of the window 100, so as to be generally horizontal when the window 100 is installed in a wall. The outer surface 122 can be provided with longitudinal grooves 123 that can facilitate securing the window 100 into a wall, by, for example, retaining concrete of a poured concrete wall.

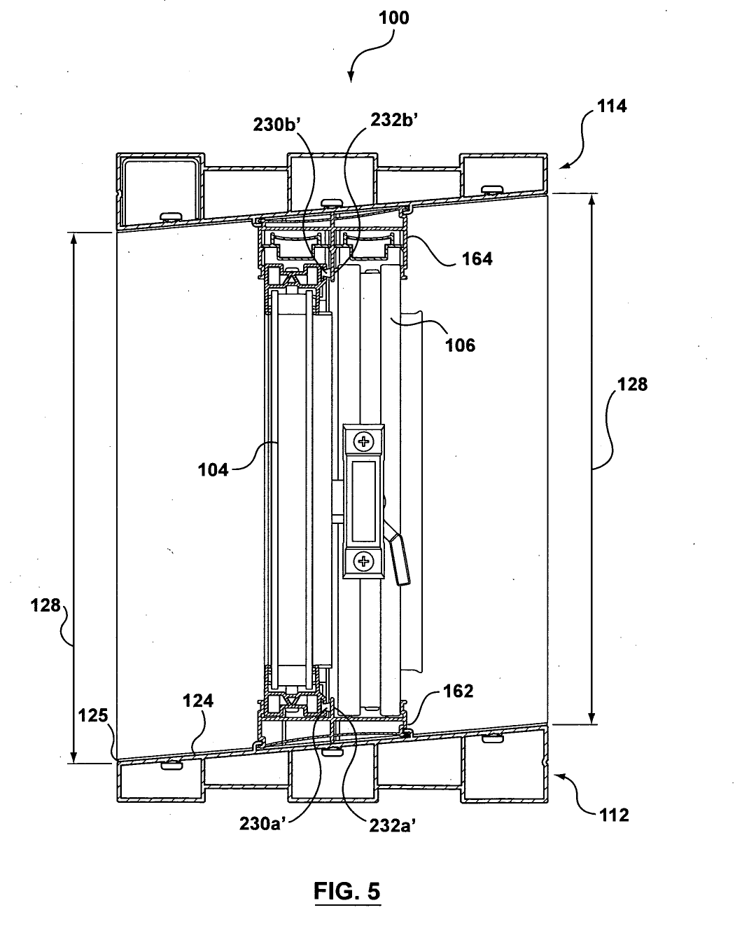

The inner surface 124 of the sill 112 is, in the embodiment illustrated, inclined with respect to the horizontal, by an incline angle 126. The incline angle 126 can be, for example, but not limited to, about five degrees. The inclined inner surface 124 of the sill 112 can facilitate draining water that may impinge or collect on the inner surface 124. Such water can be drawn by the force of gravity along the inclined inner surface 124 outwards to the front end 125 of the sill 112, or in other words, towards the exterior face 108 of the window 100 for the embodiment illustrated in FIGS. 4 and 5.

Since, in accordance with one embodiment of the present invention, the header 114 has the same profile as the sill 112, the header 114 has the same features as the sill 112, such as an outer surface 122 and inner surface 124. For clarity, when referring specifically to features of the header 114 rather than the sill 112, like reference characters will be used, with the addition of a prime suffix. Accordingly, the header 114 has an inner surface 124′ directed towards the sill 112, and an outer surface 122′ opposite the inner surface 124′. The inner surface 124′ is inclined to the horizontal (i.e. inclined relative to the plane of outer surface 122′) by an incline angle 126′ equal to incline angle 126.

In the assembled master frame 102 of the illustrated embodiment of the window 100 (with reference again to FIGS. 4 and 5), the sill 112 is oriented so that the inner surface 124 slopes downwards from the interior face 110 to the exterior face 108. In other words, the height of the sill 112 in cross-section is greater at the interior face 110 than at the exterior face 108. The header 114 is positioned in reverse, so that the height (or thickness) of the header 114 is greater at the exterior face 108 than at the interior face 110. This configuration provides an embodiment of the window 100 having a generally constant spacing 128 between parallel inclined inner surfaces 124 and 124′ of the sill 112 and header 114, respectively (FIG. 5). The constant spacing 128 can provide advantages associated with, for example, but not limited to, manufacturing of the jamb members 116 and 118, as described in greater detail subsequently.

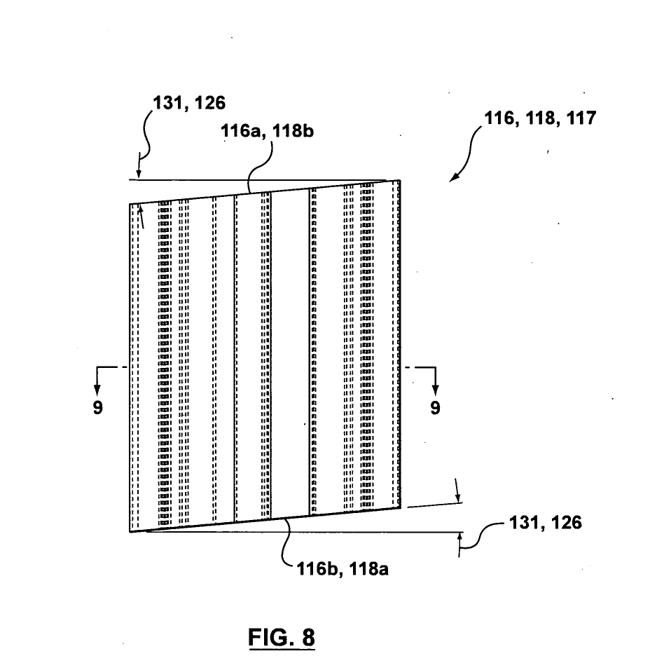

Referring now to FIGS. 3 and 8, a single extrusion 117 can be used to provide the left and right jamb members 116 and 118. In other words, the jambs 116 and 188 can, in accordance with the present invention, have a common profile so that a length of the extrusion 117 can serve as either the left jamb 116 or right jamb 118. This can simplify inventory stocking requirements, and can facilitate manufacture and tooling costs since both jambs 116 and 118 can be cut from a common extrusion 117.

In the embodiment illustrated, the left and right jambs 116 and 118 each have respective upper end faces 116a, 118a and lower end faces 116b, 118b that are parallel and inclined with respect to the horizontal by a jamb face angle 131. The jamb fae angle 131 can be equal to the incline angle 126, so that the end faces of the jambs abut the inclined inner surfaces 124′ and 124 of the header 114 and sill 112, respectively, in generally flush engagement. To form multiple individual jambs 116, 118, the extrusion can be cut with parallel oblique cuts spaced apart by the spacing distance 128.

The oblique cuts made along a length of extrusion 117 to produce jambs 116 and 118 can be cut at an angle equal to the jamb face angle 119, relative to a transverse axis of the extrusion. A single oblique cut can generate one end face of one jamb and another end face of another jamb, since the upper and lower end faces are parallel. This can advantageously simplify production of the jambs 116, 118. The simultaneous provision of two end faces in a single cut can also reduce material waste, since no scrap is generated between cuts as would be the case, for example, if only one of the surfaces 124, 124′ were inclined.

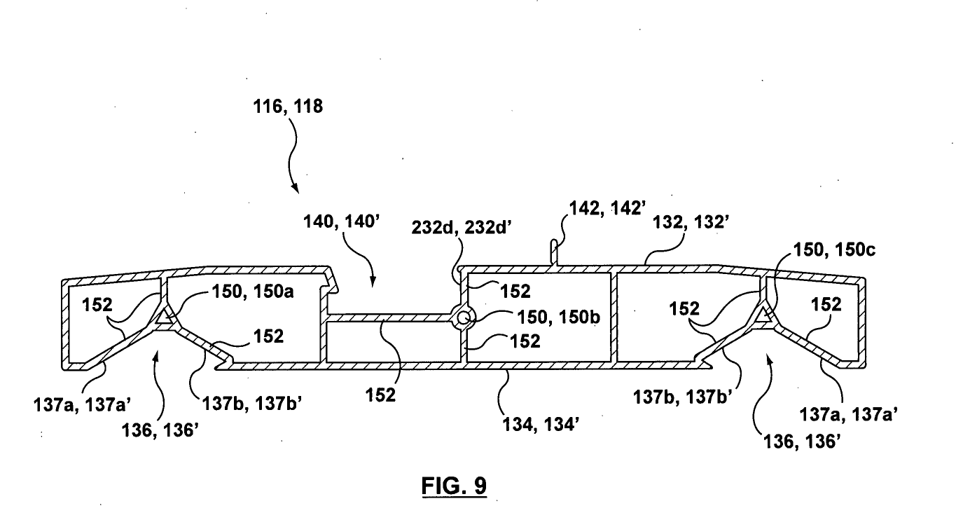

Referring now to FIGS. 3 and 9, the left jamb 116 has an inner surface 132 directed towards the right jamb 118, and an outer surface 134 opposite the inner surface 132. The outer surface 134 can be provided with longitudinal grooves 136 extending the length of the jamb 116, which can be defined by inwardly sloped sidewalls 137a and 137b (FIG. 8). The longitudinal grooves of the inner surface 132 can be provided with a channel 140 and a protruding rib 142 for purposes to be described hereinafter. The right jamb 118 has corresponding features denoted by like reference characters with “prime” suffix.

As best seen in FIG. 3, to assemble the master frame 102, the left and right jambs 116 and 118 can be positioned between the sill 112 and header 114 such that the end faces 116a, 116b and 118a, 118b are in parallel alignment with the inner surfaces 124 and 124′. A foam gasket 146 can be provided between each of the end faces 116a, 116b, 118a, 118b and the adjoining inner surfaces 124, 124′ of the sill 112 and header 114 to aid in sealing the respective joint interfaces. The screws 120 can then be secured through the outer surfaces 122 and 122′ of the sill 112 and header 114 and into engagement with the adjoining end faces 116a, 116b, 118a, 118b of the left and right jambs 116 and 118.

To facilitate securing the jambs 116 and 118 to the sill 112 and header 114, the sill 112 and header 114 can be provided with holes 148 and 148′, respectively, through which the shank of the screws 120 can pass. The jambs 116 and 118 can be provided with screw bosses 150 into which the threads of the screws 120 can bite and be anchored.

As best seen in FIG. 9, in the embodiment illustrated, the jambs 116 and 118 are provided with three screw bosses 150, identified as 150a, 150b, and 150c. The screw bosses 150a, 150b, and 150c can be in the form of elongate hollow structures extending along the length of the jambs 116, 118, and positioned between the inner and outer surfaces 132, 134, respectively. The screw bosses 150 can be supported in position by one or more webs 152 extending between an outer surface of the screw bosses 150 and the inner and outer surfaces 132 and 134. The screw bosses 150 and the webs 152 can be extruded with the respective sill 112 and header 114 extrusions.

In accordance with the present invention, one or more of the screw bosses 150 can have a triangular shape in cross-section. In the embodiment illustrated, the screw bosses 150a and 150c are triangular in shape, and the screw boss 150b is circular, although screw boss 150b could also be provided with a triangular, rather than circular, shape in cross-section. The inventors have discovered that a triangularly shaped screw boss 150 provides a number of advantages over bosses with other shapes, such as circular or square. These advantages can include increased strength and rigidity of the screw boss 150 and its respective extrusion, and increased quality and/or processing speed when manufacturing the extrusions.

Referring to FIGS. 3, 4, and 5, the window 100 is further provided with tracks 162, 164 for supporting the sashes 104 and 106 within the master frame 102. In the embodiment illustrated, a sill track 162 is secured to the sill 112, and a header track 164 is secured to the header 114.

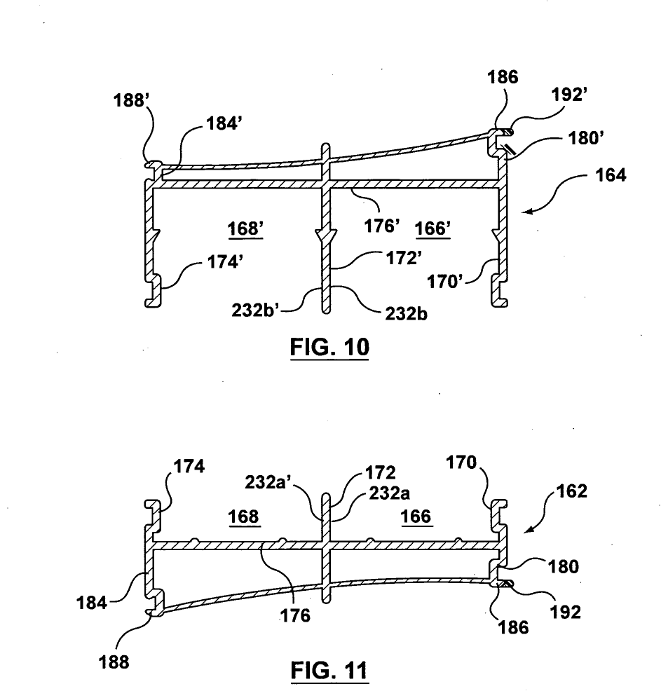

Further details of the sill track 162 and header track 164 can be seen in FIGS. 10 and 11. The sill track 162 (FIG. 11) has two parallel channels, namely, an interior sill channel 166 and an exterior sill channel 168, each of which extend along the length of the sill track 162. The interior sill channel 166 is defined by generally vertical and spaced apart interior sidewall 170 and divider wall 172. The exterior sill channel 168 is generally defined by the divider wall 172 and an exterior sidewall 174 spaced apart from the divider wall 172. Each of the sidewalls 170, 174 and the divider wall 172 extend upward from a channel base panel 176.

The sill track 162 is further provided with interior and exterior legs 180 and 184, respectively. The interior and exterior legs 180, 184 can extend generally downward from the base panel 176, opposite the interior and exterior sidewalls 170 and 174, respectively. The legs 180, 184 are adapted to support the track 162 atop the inner surface 124 of the sill 112. In the embodiment illustrated, the exterior leg 184 is taller than the interior leg 180 (relative to the base panel 176) to accommodate the incline 126 of the inner surface 124 and support the base panel 176 in a generally horizontal plane in an installed window 100 when assembled as illustrated.

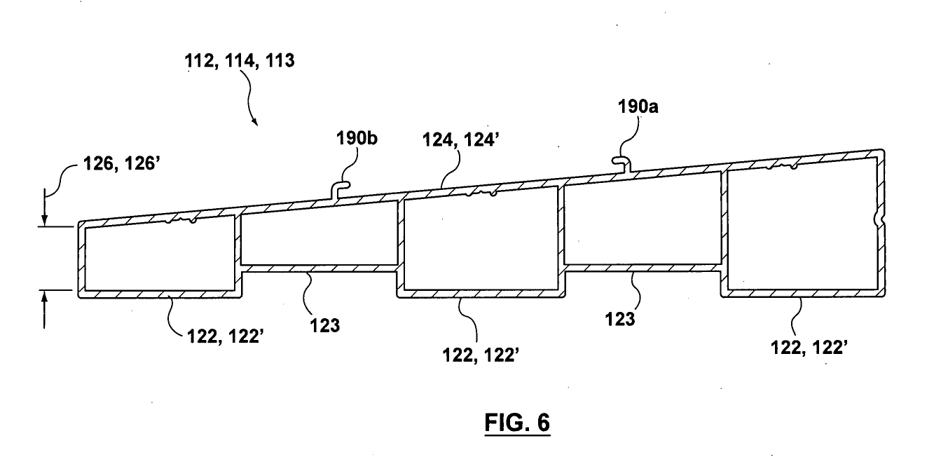

To facilitate assembly of the sill track 162 to the sill 112, the lower ends of the legs 180, 184 can be provided with interior and exterior assembly tabs 186 and 188, respectively. The tabs 186, 188 can be adapted to engage opposed retaining claws 190a and 190b provided along the inner surface 124 of the sill 112 (FIG. 6). To facilitate sealing the joint between the sill track 162 and the sill 112, the interior assembly tab 186 can be provided with a sealing fin 192 at its interior tip. The sealing fin 192 can be of a softer, flexible material that can be coextruded with the sill track 162 and that can sealingly engage the retaining claw 190a of the sill 112. The sealing fin 192 can reduce or eliminate the need for caulking between the sill track 162 and the sill 112.

The header track 164 (FIG. 10) has features that generally correspond to the sill track 162 and which are identified with like reference characters with a prime suffix. Thus the header track 164 has an interior channel 166′ and an exterior channel 168′ separated by a divider wall 172′. The header track 164 has an interior leg 180′ that is longer than the exterior leg 188′, to accommodate the incline 126′ of the inner surface 124′ of the header 114. Also, the interior and exterior sidewalls 170′ and 174′ as well as the divider wall 172′ are generally greater in height than the corresponding features 170, 174, and 172 of the sill track 162. This provides the header track 164 with channels 166′ and 168′ that have a greater depth for accommodating lift-up of the sashes 104 and 106 for installation and removal of the sashes 104 and 106 from the master frame 102.

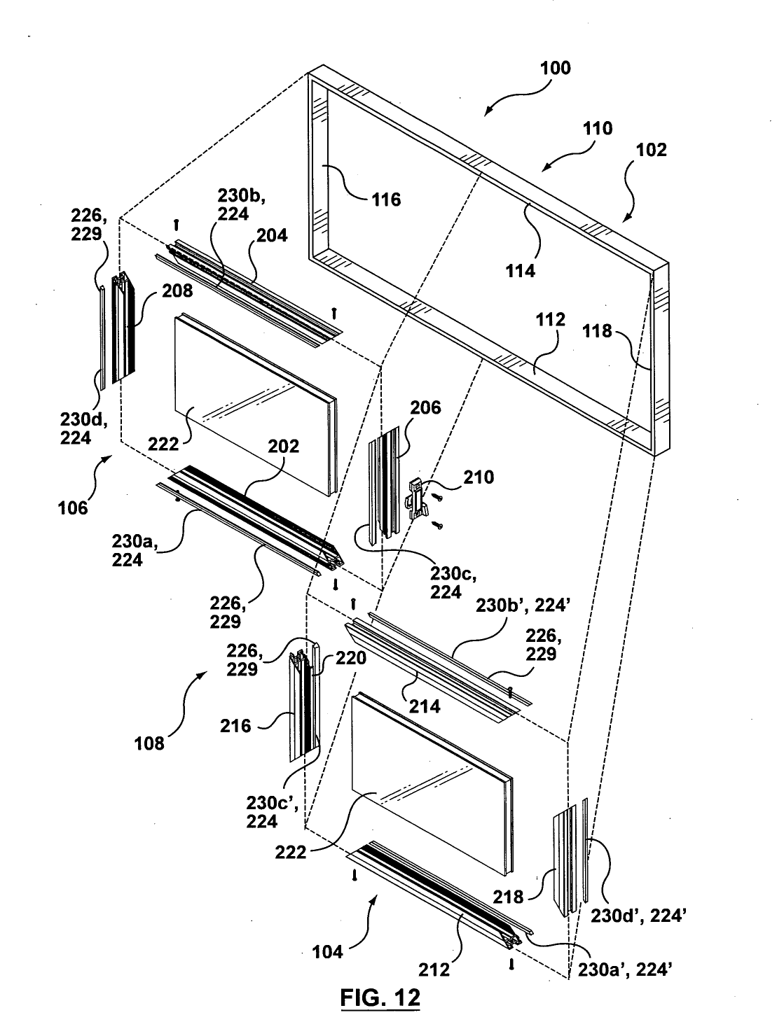

Referring now to FIG. 12, further details of the fixed sash 104 and operable sash 106 will be described. In the embodiment illustrated, the operable sash 106 has opposed lower and upper horizontal sash members 202 and 204, respectively, and opposed inner and outer vertical sash members 206 and 208, respectively, that are secured together to form a generally rectangular sash frame. The outer vertical sash member 208 is adapted to abut the vent side jamb 116 of the master frame 102 when the operable sash 106 is moved to the closed position. The inner vertical sash member 206 is, in the embodiment illustrated, provided with a sash lock 210 for releasably engaging the fixed sash 104 so that the operable sash 106 can be locked in the closed position. The inner vertical sash member 206 is also referred to herein as a lock rail 206.

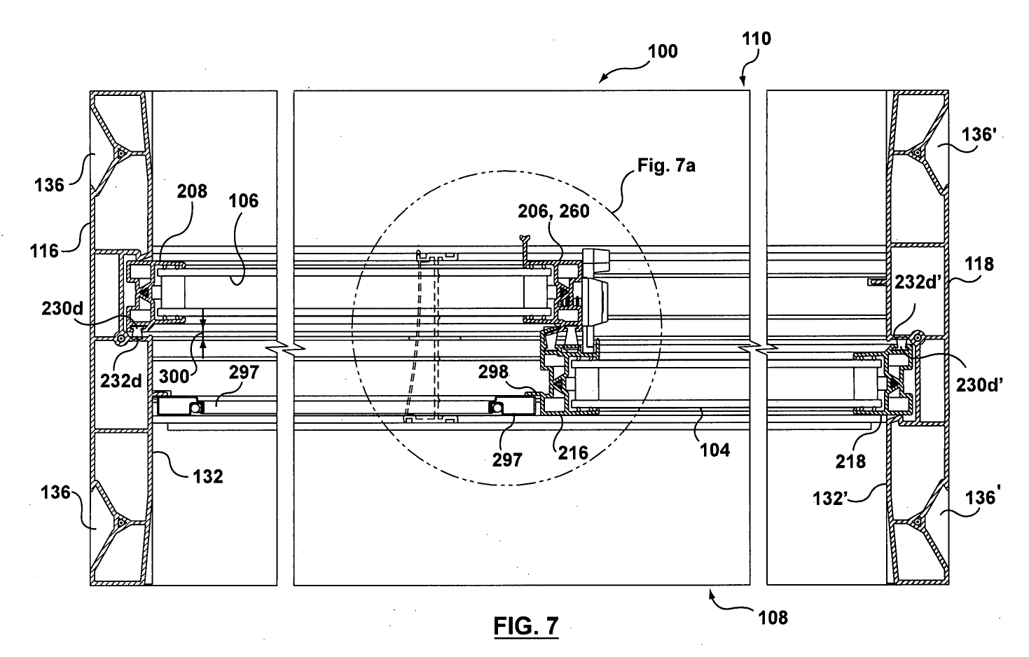

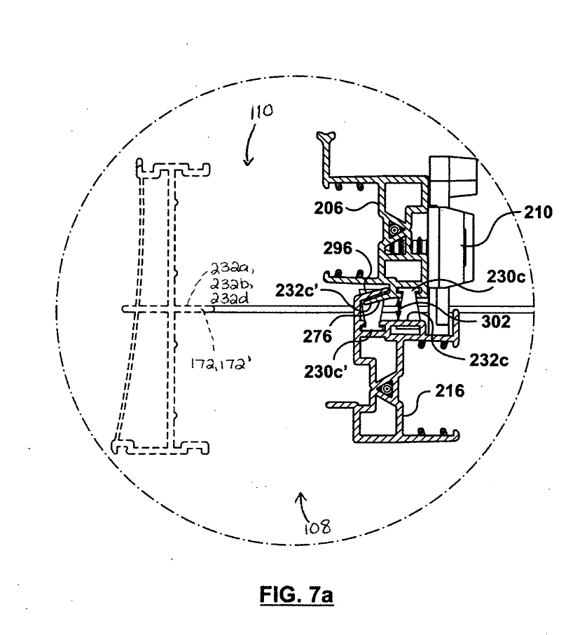

The fixed sash 104 is similarly provided with lower and upper horizontal sash members 212 and 214, respectively, and inner and outer vertical sash members 216 and 218, respectively. The inner vertical sash member of the fixed sash 104 is, in the embodiment illustrated, provided with a keeper element 220 to engage with the sash lock 210. The inner vertical sash member 216 is also referred to herein as a keeper rail 216. The lock rail 206 and keeper rail 216 generally overlap (in registration) when the window is closed (FIGS. 2 and 7).

Each of the sashes 106 and 104 are provided with a glazing unit 222 extending between the opposed sash frame members 202, 204, 206, 208 and 212, 214, 216, 218 of the respective sashes. The sashes 104 and 106 are further provided with seals 224 and 224′, respectively, for sealing out the weather when the window 100 is closed.

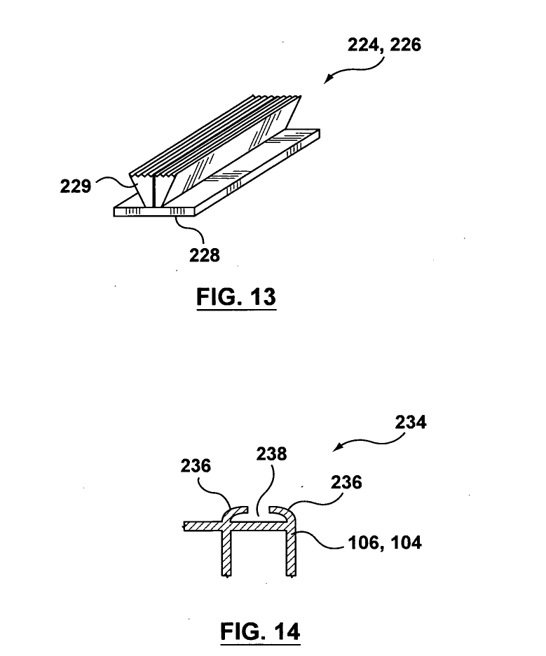

Referring now to FIGS. 12 and 13, in the embodiment illustrated, the seals 224, 224′ comprise lengths of weatherstripping 226 secured along each of the sash frame members 202, 204, 206, 208 and 212, 214, 216, 218 of the respective sashes 106 and 104. The weatherstripping 226 has a flanged spine 228 with a synthetic pile 229 extruding along a central portion of the spine 228.

Furthermore, in the embodiment illustrated (FIG. 12), the seals 224 of the operable sash 106 include seal segments 230a, 230b, 230c, and 230d along each of the sash members 202, 204, 206, and 208, respectively. The seals 224′ of the fixed sash 104 include seal segments 230a′, 230b′, 230c′, and 230d′ along each of the sash members 212, 214, 216, and 218, respectively. The pile 229 of the weatherstripping 226 of the seals 224 of the operable sash 106 is directed towards the exterior face 108 of the window 100. The pile 229 of the weatherstripping 226 of the seals 224′ of the fixed sash 104 is directed towards the interior face 110 of the window 100.

When the operable sash 106 is in the closed position, the seal segment 230d (attached to member 208) is adapted to engage a seal surface 232d provided in the sash pocket 140 of the vent side jamb 116 (see FIGS. 7 and 9). The seal segment 230c is adapted to engage a seal surface 232c provided on the keeper rail 216 of the fixed sash 104 (FIG. 7a). The seal segments 230a and 230b are adapted to engage interiorly facing surfaces 232a and 232b of the respective divider walls 172 and 172′ of the sill track 162 and header track 164 (FIGS. 4, 10, and 11).

Referring now FIGS. 12 and 15, to attach the weatherstripping 226 to the operable sash 106, the operable sash 106 is provided with a seal coupler (also called an attachment track) 234 that extends generally continuously around the perimeter of the operable sash 106. In the embodiment illustrated, the seal coupler 234 includes coupler segments 234a, 234b, 234c, and 234d along each of the sash members 202, 204, 206, and 208, respectively. Each of the segments of the seal coupler 234 has opposed retaining rails 236 (FIG. 14) forming a T-groove 238 into which the flanged spine (or backing) 228 (FIG. 13) of a length of weatherstripping 226 can be inserted and secured in a press-fit arrangement.

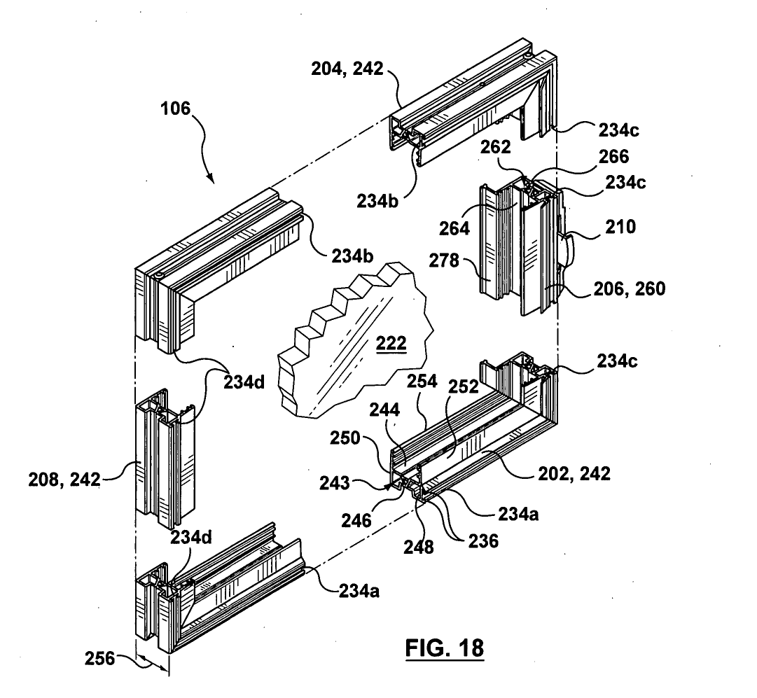

As been seen in FIGS. 15 and 18, according to the present invention, the seal coupler 234 of the operable sash 106 extends generally continuously around the perimeter of the sash 106, in a plane parallel to the glazing 222. Each of the coupler segments 234a, 234b, 234c, and 234d are generally coplanar, and intersect at respective points of intersection 240a, 240b, 240c, and 240d along abutting mitered ends of the members 202, 204, 206, and 208. In other words, the seal coupler 234 for attaching the weatherstripping 226 to the operable sash 106 does not have any steps in a direction orthogonal to the glazing 222. This can advantageously provide a continuous perimeter seal for the operable sash 106, without the need for additional “orthogonal” seal elements, such as dust plugs.

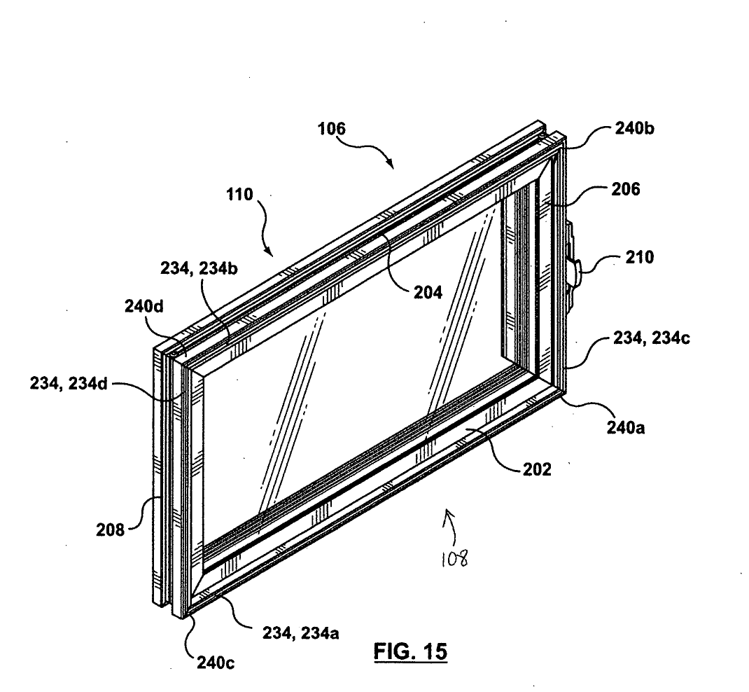

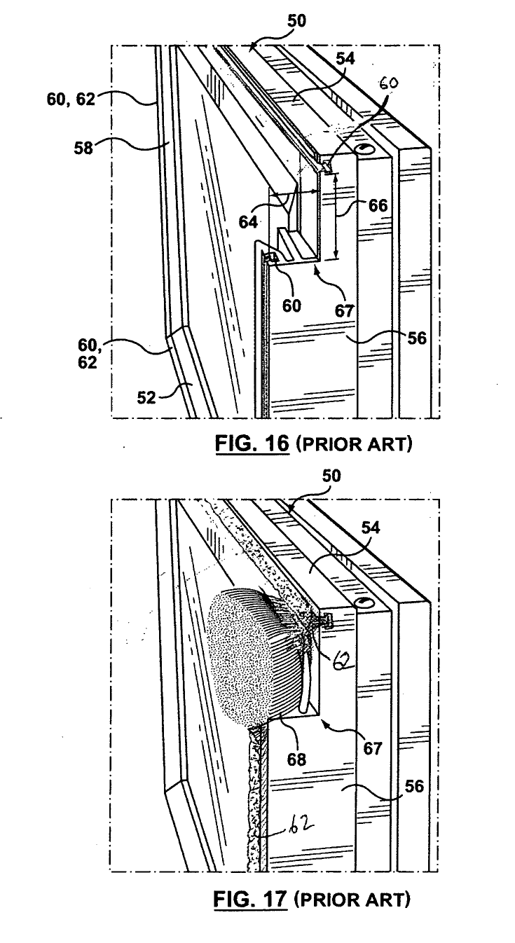

The use of dust plugs can be understood more clearly with reference to FIGS. 16 and 17. In FIGS. 16 and 17, a prior art sash 50 is illustrated, having lower and upper horizontal members 52 and 54, and inner and outer vertical members 56 and 58, respectively. A seal slot 60 for weatherstripping 62 extends along the horizontal members 52 and 54, and along the outer vertical member 58, in a generally continuous, coplanar configuration. Along the inner vertical member 56, however, the seal slot 60 is orthogonally offset from the slots 60 in the members 52, 54 and 58 by orthogonal offset 64. Furthermore, the seal slot 60 along the inner vertical member 56 stops vertically short of the upper member 54, presenting a vertical seal gap 66. The orthogonal offset 64 and seal gap 66 can result at least in part from cutting a notch 67 in the upper end of the member 56 to provide lift-out clearance between the upper surface of the sash 50 and the lower surface of a header of a frame into which the sash 50 is to be installed. A similar notch 67 is typically provided at the lower end of the member 56 to accommodate a sill.

To seal off the area around the notch 67, prior art sashes 50 are typically provided with a dust plug 68 (FIG. 17). However, the inventors of the present invention have found that dust plugs 68 are often not particularly effective at sealing out the weather, that dust plugs 68 add cost (both in terms of time and materials) to manufacture of windows, and that dust plugs 68 can detract from the overall finished aesthetics of the window.

The continuous and coplanar configuration of the seal coupler 234 of the operable sash 106 can be seen in further detail in FIG. 18. As well, the extrusion profiles for the members 202, 204, 206 and 208 of the operable sash 106 can be seen in FIG. 18. In the embodiment illustrated, the lower and upper horizontal members 202 and 204, and the outer vertical member 208 have a common extrusion profile 242. The lock rail 206 has an extrusion profile 260.

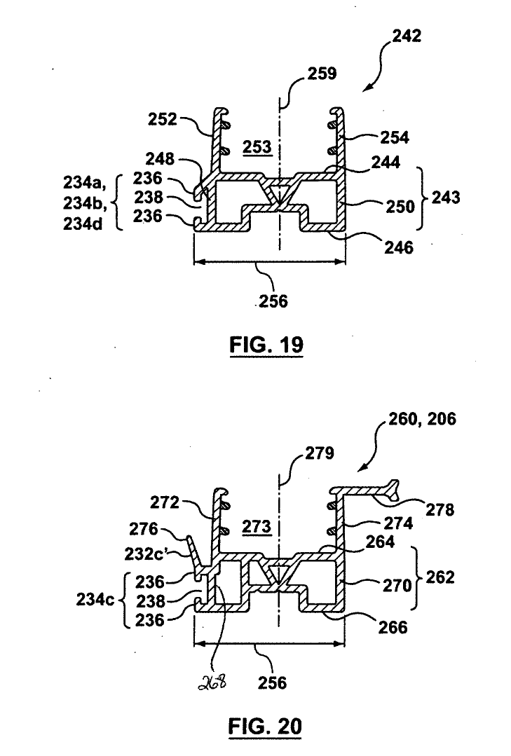

Referring to FIGS. 18 and 19, the extrusion 242 has a central body 243 with an inner face 244 adapted to face the glazing 222, an outer face 246 opposite the inner face 244, and opposed side faces 248 and 250 extending between the inner and outer faces 244 and 246. The first side face 248 is, in the embodiment illustrated, provided with the retaining rails 236 of the seal coupler 234, and is also referred to as the seal carrier face 248.

The extrusion 242 is further provided with spaced apart glazing retaining walls 252 and 254 extending generally perpendicularly from the inner face 244, opposite the side faces 248 and 250. The walls 252 and 254 and the inner surface 244 cooperate to form a glazing recess 253 for engaging the peripheral portion of the glazing 222. In the embodiment illustrated, the seal coupler 234 (identified at segments 234a, 234b, and 234d in FIG. 19) is laterally outboard of the central body 243, and is laterally outboard of the glazing recess 253. In the embodiment illustrated, the seal coupler 234 is offset from the seal recess 253 by lateral offset 255.

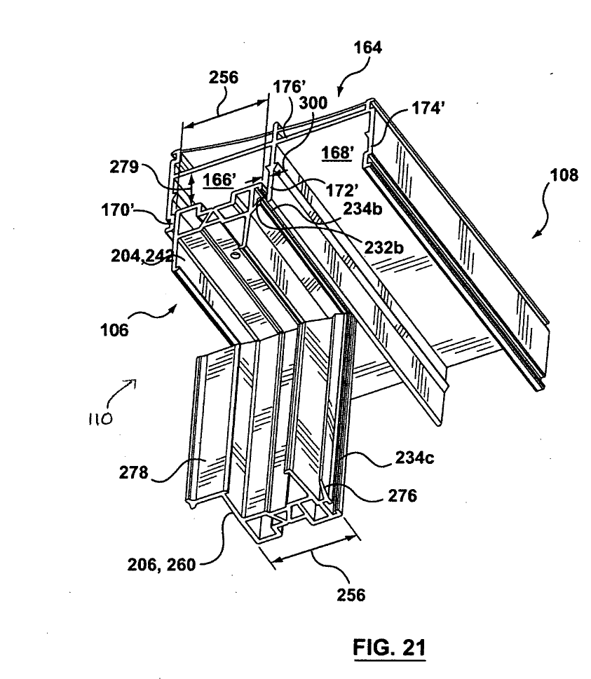

The extrusion 242 in the illustrated embodiment has a width 256 extending perpendicularly from the side face 250 to a distal surface of the retaining rails 236. The width 256 therefore encompasses, in a direction normal to the glazing 222, the width of the central body 243 plus the seal coupler 234 of the extrusion 242. The width 256 of the extrusion 242 is sufficiently narrow to fit within the interior channel 166′ of the header track 164 (FIG. 21).

The extrusion 260 for the lock rail 206 is similar in structure to the extrusion 242. The extrusion 260 has a central body 262 with an inner face 264 adapted to face the glazing 222, an outer face 266 opposite the inner face 264, and opposed side faces 268 and 270. The extrusion 260 is also provided with a slide catch 276 for engaging the check rail 216 of the fixed sash 104, when the operable sash 106 is slid to the closed position (see FIG. 7a). This engagement can provide improved weather resistance and security for the window 100. In the embodiment illustrated, the slide catch 276 extends from one of the seal retaining rails 236 and along, but spaced apart from, sidewall 272.

In the embodiment illustrated, the extrusion profile is also provided with a leg 278 extending orthogonally from the glazing retaining sidewall 274. The leg 278 can serve as a handle to be quipped when sliding the sash 106 between open and closed positions.

The extrusion 260 has a width 265 that encompasses the width (normal to the glazing 222) of the central body 262 plus the seal coupler segment 234c. In the embodiment illustrated, the width 265 is the same as the width 256 associated with the extrusion 242. The upper end of the lock rail 206 can fit within the channel 166′ of the header track 64 without removing any portion of the coupler segment 234c (FIG. 21). The seal coupler segment 234c is laterally offset from the seal recess 273 by a lateral offset equal to the lateral offset 255, so that the seal coupler 234 is spaced laterally apart from the glazing recess (and hence glazing 222) by a uniform amount around the periphery of the sash.

Lift clearance 279 is provided between the upper horizontal member 204 of the sash 106 and the base panel 176′ of the header track 164, so that the sash 106 can be lifted clear (at its lower end) of the sill track 162 for installation and removal of the sash 106 into and from the master frame 102.

It is shown that the slide catch 276 and handle 278 have portions that extend laterally beyond the width 256 of the extrusion 260. These elements, in the illustrated embodiment, are configured so as not to interfere with the required lift-up of the sash 106 into the channel 166′, without the need for separate cuts or notches. However, even if they did require separate cuts for clearance, the seal coupler segment 234c would remain intact, and extend continuously to intersect or abut the coupler segment 234b.

Similarly, the coupler segment 234c at its lower (sill) end is adapted to fit within the channel 166 in the sill track 162, without the requirement for any cuts, notching, or other discontinuity.

Accordingly, the operable sash 106 provides a seal coupler 234 that is generally continuous around the perimeter of the sash 106, and in a plane that is parallel to and spaced apart from the glazing 222. The seal coupler segments 234a, 234b, 234d (of extrusion 242) and 234c (extrusion 260) are positioned laterally outboard of the respective proximate sidewalls 252 and 272. The T-slots 238 for retaining the seals 230 are spaced further away from respective widthwise centerlines 259 and 279 of the glazing recesses 253 and 273 than the respective sidewalls 252 and 272 nearest the T-slots 238.

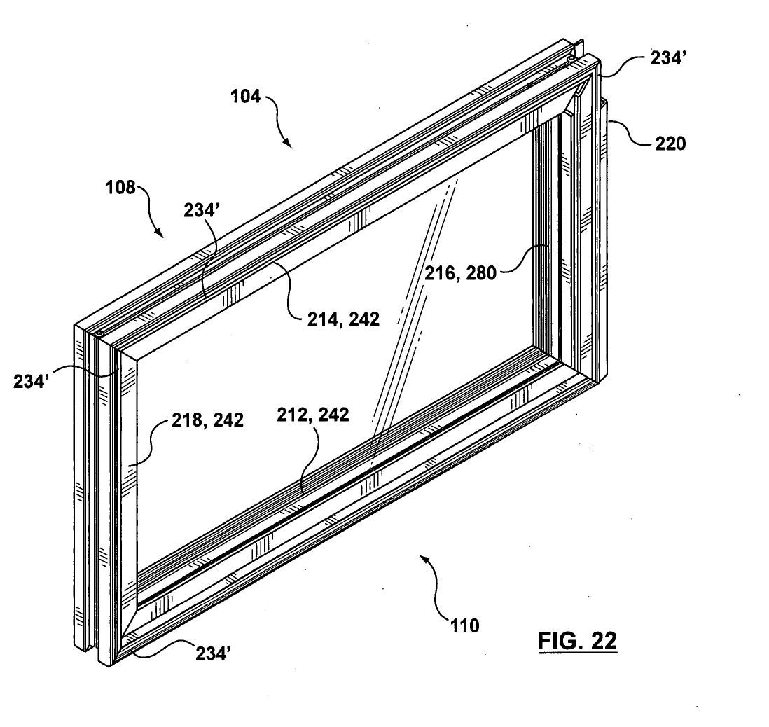

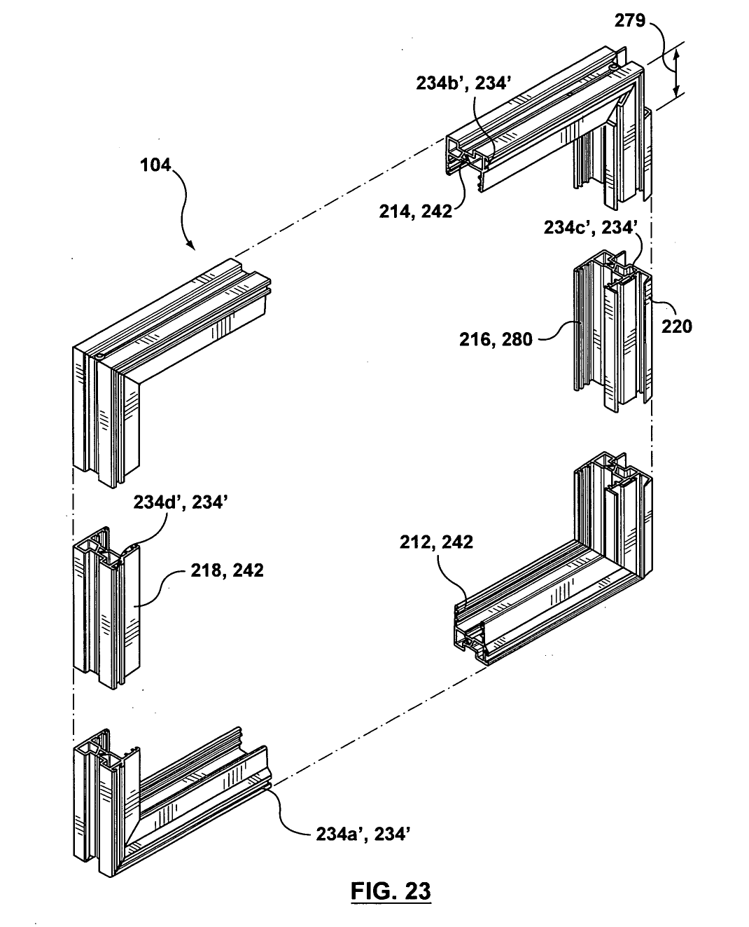

Details of the fixed sash 104 can be seen in greater detail in FIGS. 22 and 23. The horizontal members 212 and 214, and the outer vertical member 218 are each constructed of the extrusion 242. The keeper rail 216 is constructed of an extrusion 280.

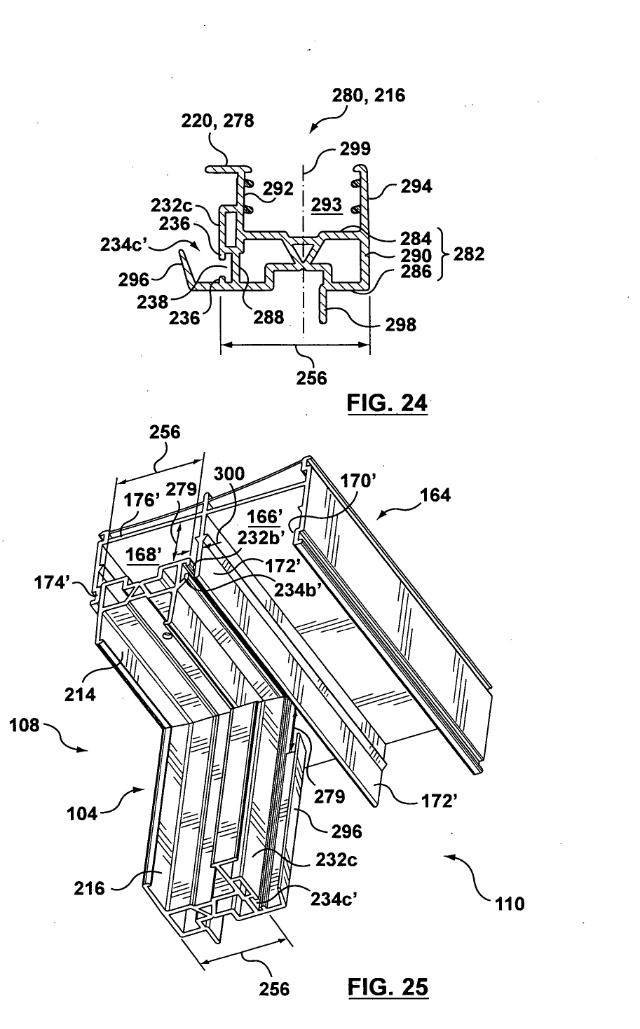

As best seen in FIG. 24, the extrusion 280 has a central body 282 with an inner face 284, outer face 286, and side faces 288 and 290. Sidewalls 292 and 294 extend from the inner face 284 to form a glazing recess for receiving the glazing 222. The keeper element 220 is provided in the form of a leg 278 extending orthogonally from the sidewall 292, to be engaged by the lock 210 (FIG. 7a). A seal coupler segment 234c′ including retaining rails 236 and T-slot 238 is provided along the side face 288 of the central body 282. The seal surface 232c is provided along portions of the side face 288 and sidewall 292.

The extrusion 280 is also provided with a fixed catch 296 extending along and spaced away from the side face 288, and adapted to engage the slide catch 276 of the lock rail 206. A screen abutment surface 298 is also provided, extending from the outer face 286, for supporting a screen element 297 (see FIG. 7).

Referring to FIGS. 24 and 25, the extrusion 280 has, in the embodiment illustrated, the same width 256 measured from the side face 290 to a distal surface of the retaining rails 236 of the coupler segment 234c′. The width 256 is sufficiently narrower to fit within the clearance 168′ of the header track 164. The upper end of the check rail 216 can be lifted upward into the clearance 279 for installing and removing the sash 104, without cutting or notching the coupler segment 234c′. In the embodiment illustrated, the fixed catch 296 does require trimming at its upper (header) end to provide the clearance 279 between the catch 296 and the divider wall 172′ of the header track 164. The coupler segment 234c remains intact, and extends continuously to intersect or abut the coupler segment 234b′.

The interaction of the seals 230 and the seal surfaces 232 can be seen in FIGS. 4 and 7. Referring to FIG. 4, the seal surfaces 232a and 232b are portions of the divider walls 172 and 172′, respectively, of the sill track 162 and header track 164. The surfaces 232a and 232b face towards the interior face 110 of the window 100, and are engaged by the seal segments 230a and 230b, respectively, of the operable sash 106. With reference to FIG. 7, the seal surface 232d on the vent side jamb 116 is engaged by the pile 229 of the weatherstripping 226 of the seal segment 230d of the operable sash 106.

As best seen in FIG. 7a, the seal surface 232c is engaged by the seal segment 230c of the operable sash 106. In the embodiment illustrated, the seal surfaces 232a, 232b, and 232d are generally coplanar, and spaced apart from the respective seal coupler segments 234a, 234b, and 234d by a frame clearance 300 (FIG. 7). The seal surface 232c is spaced apart from the respective seal coupler segment 234a by a stile clearance 302, which, in the embodiment illustrated, is greater than the frame clearance 300. This increased spacing is caused by the relative lateral position of the seal surface 232c. The seal surface 232c is not coplanar with the seal surfaces 232a, 232b, and 232d, but is displaced towards the exterior face 108 of the window 100. This positioning ensures that the seal surface 232c does not, relative to the central body 282 of the keeper rail 216, cross over the divider walls 172 and 172′ of the sill and header tracks 162 and 164. In other words, the width of the central body 282 with the seal surface 232 (shown at width 256 in FIGS. 24 and 25) is sufficiently narrow to fit within the channel 168′ so that the seal surface 232c can extend continuously along the length of the keeper rail 216, without cut-outs or notching at the ends received in the channels 166 and 166′. This ensures that the seal surface 232 is present for engagement by the weatherstripping 226 along the entire length of the seal segment 230c.

To ensure that both clearances 300 and 302 are sealed by the seals 230, the weatherstripping 226 can have a pile 229 with a height long enough to span the larger stile clearance 302. The pile 229 is sufficiently flexible and compressible so that excess length along seal segments 230a, 230b, and 230d will not interfere with satisfactory sealing action and operation of the window 100.

Alternatively, separate weatherstripping 226 with shorter and longer piles 229 can be used to seal the clearances 300 and 302, respectively.

It is to be understood that what has been described are preferred embodiments of the invention. The invention nonetheless is susceptible to certain changes and alternative embodiments without departing from the scope of the subject invention.

1. A frame assembly for a window, comprising:
a) a master frame; and
b) at least one sash frame slidably supported in the master frame, the sash frame having a seal coupler for attachment of a weather seal to the sash frame, the seal coupler extending generally continuously around the perimeter of the sash frame.

2. The frame assembly of claim 1, wherein the sash frame has a peripheral glazing recess for supporting a glazing pane therein, and the seal coupler is laterally offset from the glazing recess by a uniform amount around the perimeter of the sash frame.

3. The frame assembly of claim 1, wherein the sash frame includes upper and lower horizontal frame members extending between spaced apart vertical frame members, the horizontal and vertical frame members comprising extruded lineals cut to length and connected together at their ends.

4. The frame assembly of claim 3, wherein the extruded lineals integrally include the seal coupler.

5. The frame assembly of claim 4, wherein the upper and lower horizontal frame members have a common sash extrusion profile.

6. The frame assembly of claim 5, wherein at least one of the vertical frame members has the common sash extrusion profile.

7. The frame assembly of claim 3, wherein the seal coupler comprises a pair of inwardly directed retaining rails forming a T-slot for receiving a flanged backing of a length of weatherstripping.

8. The frame assembly of claim 8, wherein each of the extruded lineals includes said pair of rails and a glazing recess for supporting a glazing pane therein, the relative lateral position of the rails and the glazing recess being constant around the perimeter of the sash frame.

9. The frame assembly of claim 1, wherein the master frame has a sill and a header extending between two spaced apart jambs, the sill, header, and jambs formed of extrusions cut to length and secured together at their ends, and wherein the sill and header comprise a sill track and a header track, respectively, providing opposed channels for slidably supporting the sash.

10. The frame assembly of claim 9, wherein the sill track and header track comprise first and second track extrusions separately attached to the sill and header, respectively.

11. The frame assembly of claim 10, wherein the attachment of the sill track and header track to the sill and header comprises a snap fit assembly.

12. The frame assembly of claim 11, wherein the sill and header each comprise a pair of spaced apart retaining claws for engaging barbs extending from the respective sill and header tracks.

13. The frame assembly of claim 12, wherein the claws are integrally extruded with the sill and header extrusions.

14. The frame assembly of claim 13, wherein the sill and header have a common horizontal member extrusion profile.

15. The frame assembly of claim 11 wherein the sill track has a co-extruded sealing fin for bearing against the sill to seal out weather elements.

16. The frame assembly of claim 10, wherein the opposed channels have a width defining a channel width, and wherein the width of the sash frame including the seal coupler is narrower than the channel width.

17. A frame assembly for a window, comprising:
a) a master frame;
b) first and second sash frames mounted in the master frame, the first sash frame being slidable within the master frame along a sliding axis for opening and closing the window;
c) the first sash frame having a lock rail and the second sash frame having a keeper rail, the lock rail and keeper rail generally overlapping each other when the window is closed; and
d) the lock rail having a first seal coupler segment extending continuously along the entire length of the lock rail for attaching a first continuous length of weatherstripping to the lock rail.

18. The frame assembly of claim 17, wherein the lock rail comprises a first extruded lineal with mitered lock rail ends, and the first seal coupler segment is coterminous with the mitered lock rail ends.

19. The frame assembly of claim 18, wherein the first sash frame further comprises second and third seal coupler segments extending from respective ends of the first coupler segment in a direction parallel to the sliding axis.

20. The frame assembly of claim 17, wherein the keeper rail comprises a first seal surface that is disposed, when the window is closed, opposite to and extends continuously along the length of the first seal coupler segment of the lock rail for engaging said first length of weatherstripping.

21. The frame assembly of claim 20, wherein the keeper rail comprises a second extruded lineal with mitered keeper rail ends, and the first seal surface is coterminous with the mitered keeper rail ends.

22. The frame assembly of claim 21, wherein the keeper rail comprises a fourth seal coupler segment extending continuously between the mitered keeper rail ends for attaching a second length of weatherstripping to the keeper rail.

23. The frame assembly of claim 22, wherein the second sash frame further comprises fifth and sixth seal coupler segments extending from respective ends of the fourth coupler segment in a direction parallel to the sliding axis.
